(19) United States
(12) Patent Application Publication
(10) Pub. No.: US 2020/0101865 A1
(43) Pub. Date: Apr. 2, 2020

(54) DIAGNOSIS DEVICE, DIAGNOSIS SYSTEM, DIAGNOSIS METHOD, AND PROGRAM

(71) Applicant: HONDA MOTOR CO., LTD., Tokyo (JP)

(72) Inventor: Taisuke Tsurutani, Wako-shi (JP)

(21) Appl. No.: 16/565,678

(22) Filed: Sep. 10, 2019

(30) Foreign Application Priority Data
Sep. 28, 2018 (JP) 2018-183889

(51) Int. Cl. B60L 58/16; B60L 58/18; B60L 58/12; B60L 50/64

(52) U.S. Cl. CPC B60L 58/16; B60L 50/64; B60L 58/12; B60L 58/18

(57) ABSTRACT

A diagnosis device includes: an estimation unit that is configured to estimate a deterioration state of a secondary battery on the basis of an output of a sensor mounted in the secondary battery supplying power for running driving of a vehicle; a deriving unit that is configured to derive an index value representing validness of data used for estimating the deterioration state; and a request unit that is configured to request an external charger for supplying power to the secondary battery to perform a specific charging/discharging operation in a case in which the index value derived by the deriving unit is equal to or smaller than a predetermined value.

### CROSS-REFERENCE TO RELATED APPLICATION

Priority is claimed on Japanese Patent Application No. 2018-183889, filed on Sep. 28, 2018, the contents of which are incorporated herein by reference.

### BACKGROUND

### Field of the Invention

The present invention relates to a diagnosis device, a diagnosis system, a diagnosis method, and a program.

### Background

In recent years, electric vehicles that run using only motors by supplying power of secondary batteries, which are chargeable/dischargeable, to the motors and hybrid electric vehicles that include engines and motors for running and run using power including at least one of an engine and a motor are widely used. In electric vehicles and hybrid electric vehicles, it is known to display a value representing a deterioration state of a battery (state of health (SOH)) (for example, see Japanese Unexamined Patent Application, First Publication No. 2009-208484).

### SUMMARY

However, in a conventional technology, there are cases in which the accuracy of estimation of the deterioration state of a secondary battery is low.

One object of an aspect of the present invention is to improve the accuracy of estimation of the deterioration state of a secondary battery.

A diagnosis device, a diagnosis system, a diagnosis method, and a program according to aspects of the present invention employ the following configurations.

(1): According to one aspect of the present invention, there is provided a diagnosis device including: an estimation unit that is configured to estimate a deterioration state of a secondary battery based on an output of a sensor mounted in the secondary battery supplying power for running driving of a vehicle; a deriving unit that is configured to derive an index value representing validness of data used for estimating the deterioration state; and a request unit that is configured to request an external charger supplying power to the secondary battery to perform a specific charging/discharging operation in a case in which the index value derived by the deriving unit is equal to or smaller than a predetermined value.

(2): In the aspect (1) described above, the deriving unit may derive the index value based on a number of times of acquiring the output of the sensor as the data used for estimation performed by the estimation unit.

(3): In the aspect (1) or (2) described above, the deriving unit may derive the index value based on an amount of change in a charging rate of the secondary battery in accordance with charging/discharging of the secondary battery.

(4): In any one of the aspects (1) to (3) described above, an acquisition unit that is configured to acquire information representing a parking status of the vehicle is further included, and the request unit may perform the requesting in a case in which the parking status represented by the information acquired by the acquisition unit satisfies a predetermined condition.

(5): According to another aspect of the present invention, there is provided a diagnosis system including: the diagnosis device according to any one of the aspects (1) to (4); and the external charger including: a communication unit that is configured to receive the request from the diagnosis device; and an execution unit that is configured to execute the specific charging/discharging operation for the secondary battery in a case in which the request is received by the communication unit. (6): In the aspect (5) described above, the specific charging/discharging operation includes a state in which charging/discharging is performed for the secondary battery and a pause state in which charging/discharging is not performed.

(7) According to a yet another aspect of the present invention, there is provided a diagnosis method performed using a computer mounted in a vehicle, the diagnosis method including: estimating a deterioration state of a secondary battery based on an output of a sensor mounted in the secondary battery supplying power for running driving of the vehicle; deriving an index value representing validness of data used for estimating the deterioration state; and requesting an external charger supplying power to the secondary battery to perform a specific charging/discharging operation in a case in which the derived index value is equal to or smaller than a predetermined value.

(8) According to a yet another aspect of the present invention, there is provided a computer-readable non-transitory recording medium including a program causing a computer mounted in a vehicle to execute: estimating a deterioration state of a secondary battery based on an output of a sensor mounted in the secondary battery supplying power for running driving of the vehicle; deriving an index value representing validness of data used for estimating the deterioration state; and requesting an external charger supplying power to the secondary battery to perform a specific charging/discharging operation in a case in which the derived index value is equal to or smaller than a predetermined value.

According to the aspects (1) to (8) described above, the accuracy of estimation of the deterioration state of a secondary battery can be improved.

### BRIEF DESCRIPTION OF THE DRAWINGS

FIG. 1 is an explanatory diagram showing one example of the configuration of a diagnosis system.

FIG. 2 is an explanatory diagram showing the configuration of a vehicle cabin of a vehicle.

FIG. 3 is an explanatory diagram showing a diagnosis device and surrounding constituent elements.

FIG. 4 is a flowchart showing one example of a process of requesting a capacity learning operation that is performed by the diagnosis device.

FIG. 5 is a sequence diagram showing one example when a capacity learning operation is performed.

FIG. 6 is an explanatory diagram showing one example of a reliability identification table used for identifying a reliability from a sum of numbers of times of capacity learning.

FIG. 7 is an explanatory diagram showing one example of a display screen relating to a deterioration state of a battery.

FIG. 8 is an explanatory diagram showing Modified example 1 of the present embodiment.

### DESCRIPTION OF EMBODIMENTS

Hereinafter, a diagnosis device, a diagnosis system, a diagnosis method, and a program according to embodiments of the present invention will be described with reference to the drawings. In the following description, a vehicle 10 is an electric vehicle. However, the vehicle 10, for example, may be any vehicle such as a hybrid vehicle or a fuel cell vehicle in which a secondary battery supplying power for running is mounted.

### Embodiment

### [Vehicle 10]

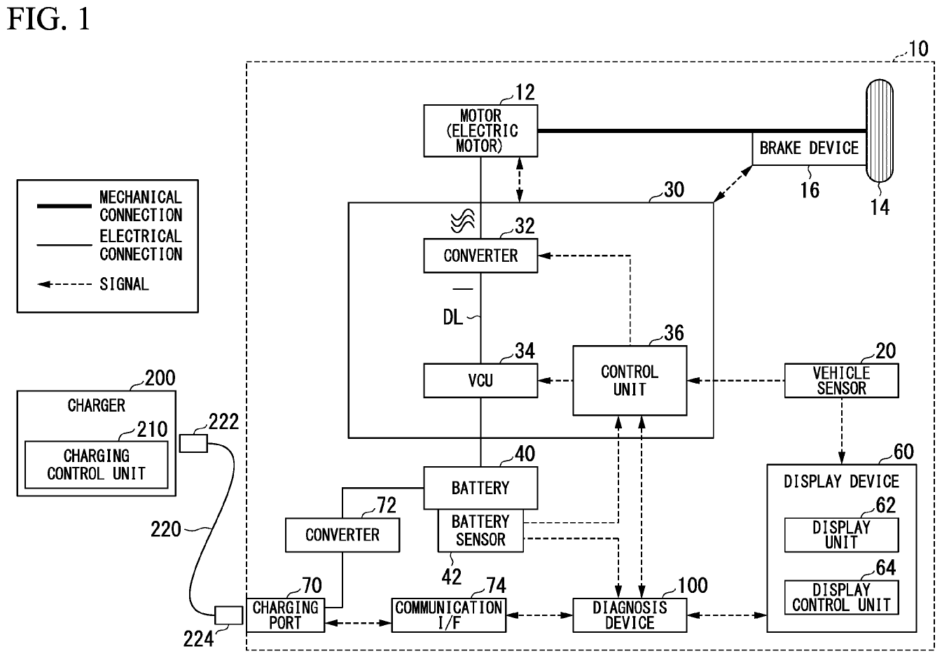

FIG. 1 is an explanatory diagram showing one example of the configuration of a diagnosis system. As shown in FIG. 1, the diagnosis system includes a vehicle 10 and a charger 200. The vehicle 10, for example, includes a motor 12, a driving wheel 14, a brake device 16, a vehicle sensor 20, a power control unit (PCU) 30, a battery 40, a battery sensor 42, a display device 60, a charging port 70, a converter 72, and a diagnosis device 100.

The motor 12, for example, is a three-phase AC electric motor. A rotor included in the motor 12 is connected to the driving wheel 14. The motor 12 outputs power to the driving wheel 14 using supplied power. In addition, the motor 12 generates power using kinetic energy of the vehicle at the time of decelerating the vehicle.

The brake device 16, for example, includes a brake caliper, a cylinder delivering hydraulic pressure to the brake caliper, and an electric motor generating hydraulic pressure in the cylinder. The brake device 16 may include a mechanism that delivers a hydraulic pressure generated in accordance with an operation on a brake pedal to the cylinder through a master cylinder as a backup. The brake device 16 is not limited to the configuration described above and may be an electronic control-type hydraulic brake device that delivers a hydraulic pressure of the master cylinder to the cylinder.

The vehicle sensor 20 includes an acceleration opening degree sensor, a vehicle speed sensor, and a brake depression amount sensor. The acceleration opening degree sensor is mounted in an acceleration pedal that is one example of an operator accepting an acceleration instruction from a driver, detects the amount of operation of the acceleration pedal, and outputs the detected amount of operation to the control unit 36 as a degree of acceleration opening. The vehicle speed sensor, for example, includes vehicle wheel speed sensors mounted in vehicle wheels and a speed calculator, derives a speed of the vehicle (vehicle speed) by combining vehicle wheel speeds detected by the vehicle wheel speed sensors, and outputs the derived speed to the control unit 36 and the display device 60. The brake depression amount sensor is mounted in the brake pedal. The brake depression amount sensor detects the amount of operation of the brake pedal and outputs the detected amount of operation of the brake pedal to the control unit 36 as the amount of depression of the brake.

The PCU 30, for example, includes a converter 32, a voltage control unit (VCU) 34, and a control unit 36. To form such constituent elements to have a configuration of one set as the PCU 30 is merely one example, and such constituent elements may be disposed in a distributed manner.

The converter 32, for example, is an AC-DC converter. A DC-side terminal of the converter 32 is connected to a DC link DL. The battery 40 is connected to the DC link DL through the VCU 34. The converter 32 converts an AC generated by the motor 12 into a DC and outputs the DC to the DC link DL.

The VCU 34, for example, is a DC-DC converter. The VCU 34 boosts power supplied from the battery 40 and outputs the boosted power to the DC link DL.

The control unit 36, for example, includes a motor control unit, a brake control unit, and a battery VCU control unit. The motor control unit, the brake control unit, and the battery VCU control unit may be replaced by separate control devices, for example, control devices including a motor ECU, a brake ECU, and a battery ECU.

The motor control unit controls the motor 12 on the basis of an output of the vehicle sensor 20. The brake control unit controls the brake device 16 on the basis of an output of the vehicle sensor 20. The battery VCU control unit calculates a state of charge (SOC; a battery charging rate) of the battery 40 on the basis of an output of the battery sensor 42 mounted in the battery 40 and outputs the calculated SOC to the VCU 34 and the diagnosis device 100. The VCU 34 raises a voltage of the DC link DL in accordance with an instruction from the battery VCU control unit.

The battery 40, for example, is a secondary battery such as a lithium ion battery. The battery 40 accumulates power introduced from the charger 200 disposed outside the vehicle 10 and discharges for running the vehicle 10. The battery sensor 42, for example, includes a current sensor, a voltage sensor, and a temperature sensor. The battery sensor 42, for example, detects a current value, a voltage value, and a temperature of the battery 40.

The battery sensor 42 outputs the current value, the voltage value, the temperature, and the like that have been detected to the control unit 36 and the diagnosis device 100.

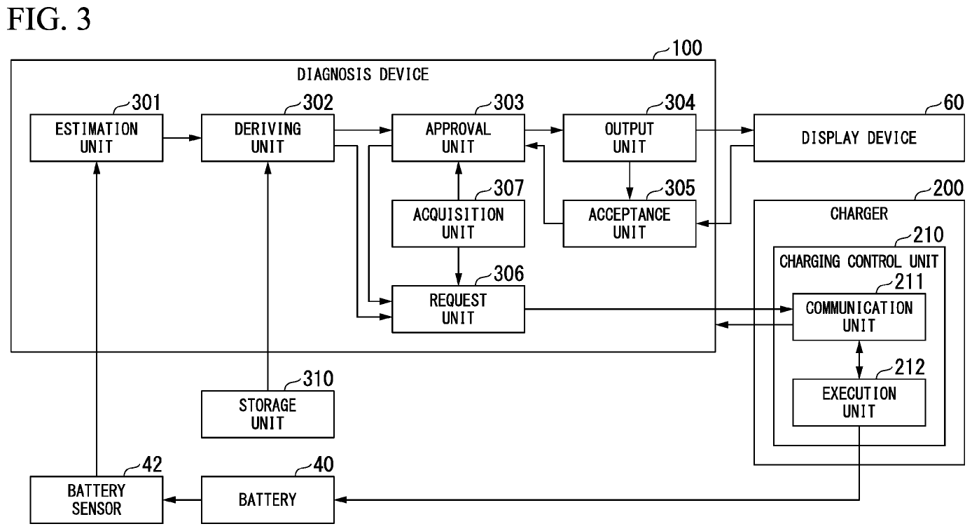

The diagnosis device 100 estimates a deterioration state (for example, a state of health (SOH)) of the battery 40 on the basis of the output of the battery sensor 42. In addition, in a case in which the reliability of data (for example, ΔSOC) used for estimating a deterioration state is equal to or lower than a predetermined value, the diagnosis device 100 requests the charging control unit 210 of the charger 200 to perform a specific charging/discharging operation through the communication I/F 74 in accordance with a user's approval. The communication I/F 74 functions as an interface between the diagnosis device 100 and the charging control unit 210. In addition, the diagnosis device 100 may be integrally disposed with the control unit 36. Details of the diagnosis device 100 will be described later with reference to FIG. 3.

The display device 60, for example, includes a display unit 62 and a display control unit 64. The display unit 62 displays information according to control of the display control unit 64. The display control unit 64 causes the display unit 62 to display information relating to the battery 40 in accordance with information output from the vehicle sensor 20, the control unit 36, and the diagnosis device 100. In addition, the display control unit 64 causes the display unit 62 to display a vehicle speed and the like output from the vehicle sensor 20.

The charging port 70 is disposed toward the outside of the vehicle body of the vehicle 10. The charging port 70 is connected to the charger 200 through a charging cable 220. The charging cable 220 includes a first plug 222 and a second plug 224. The first plug 222 is connected to the charger 200. The second plug 224 is connected to the charging port 70. Electricity supplied from the charger 200 is supplied to the charging port 70 through the charging cable 220.

In addition, the charging cable 220 includes a signal cable mounted in a power cable. The signal cable relays communication between the vehicle 10 and the charger 200. Accordingly, a power connector and a signal connector are disposed in each of the first plug 222 and the second plug 224.

The converter 72 is disposed between the battery 40 and the charging port 70. The converter 72 converts a current introduced from the charger 200 through the charging port 70, for example, an AC current into a DC current. The converter 72 outputs the converted DC current to the battery 40.

Next, the charger 200 will be described. The charger 200 includes the charging control unit 210.

When a request for a specific charging/discharging operation is received from the diagnosis device 100, the charging control unit 210 performs charging/discharging according to a specific charging/discharging operation for the battery 40. When the specific charging/discharging operation is completed, the charging control unit 210 transmits a completion notification to the diagnosis device 100.

In addition, in this embodiment, the charging system of the battery 40 is a contact type in which the charging port 70 and the charger 200 are connected through the charging cable 220 but is not limited thereto. The charging system of the battery 40, for example, may be a non-contact type and, more specifically, may be a non-contact type in which charging is performed in accordance with magnetic coupling between a power transmission coil disposed on the ground and a power receiving coil connected to the battery.

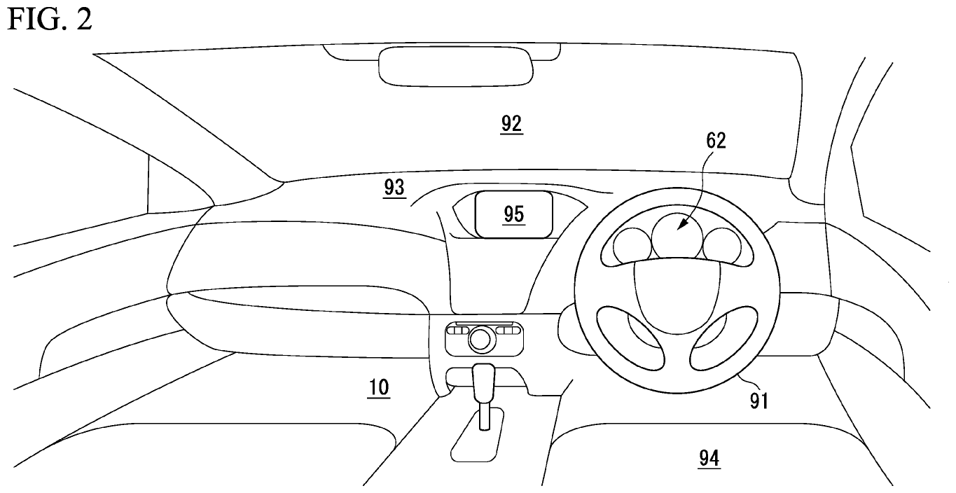

FIG. 2 is an explanatory diagram showing the configuration of the vehicle cabin of a vehicle 10. As shown in FIG. 2, for example, a steering wheel 91 controlling the steering of the vehicle 10, a front windshield 92 partitioning the inside of the vehicle from outside, and an instrument panel 93 are disposed in the vehicle 10. The front windshield 92 is a member having a light transmitting property.

A display unit 62 of a display device 60 is disposed near the front face of a driver's seat 94 on the instrument panel 93 inside the vehicle cabin. The display unit 62 is disposed such that it can be visually recognized by a driver through a gap of the steering wheel 91 or over the steering wheel 91. In addition, a second display device 95 other than the display device 60 is disposed at the center of the instrument panel 93.

The second display device 95, for example, displays an image corresponding to a navigation process executed by a navigation device (not shown in the drawing) mounted in the vehicle 10 or displays a video or the like of a partner in a video telephone call. In addition, the second display device 95 may display a television program, play back a DVD, or display a content such as a downloaded movie.

### [Diagnosis Device 100]

Next, the diagnosis device 100 and surrounding constituent elements of the diagnosis device 100 will be described with reference to FIG. 3. FIG. 3 is an explanatory diagram showing the diagnosis device 100 and the surrounding constituent elements. As shown in FIG. 3, the diagnosis device 100 includes an estimation unit 301, a deriving unit 302, an approval unit 303, an output unit 304, an acceptance unit 305, a request unit 306, and an acquisition unit 307. Such functional units are realized by the diagnosis device 100 executing a program.

The diagnosis device 100, for example, is realized by a hardware processor such as a central processing unit (CPU) executing a program (software). Some or all of such constituent elements may be realized by hardware (a circuit unit; including a circuitry) such as a large scale integration (LSI), an application specific integrated circuit (ASIC), a field-programmable gate array (FPGA), a graphics processing unit (GPU), or the like or may be realized by software and hardware in cooperation.

The estimation unit 301 estimates a deterioration state of the battery 40 on the basis of an output of a sensor (for example, the battery sensor 42) mounted in a secondary battery (for example, the battery 40) supplying power for driving running of the vehicle 10. The battery sensor 42 can detect the amount of current (Ah) flowing through the battery 40 or an output voltage of the battery 40.

Here, the deterioration state, for example, is a value estimated using an amount of change ΔAh in the charging/discharging amount Ah (ampere-hour) and an amount of change ΔSOC in the ratio of a remaining capacity (amount of charging: SOC) to a full-charge capacity. Described more specifically, the amount of change ΔAh in the charging/discharging amount, for example, is a value calculated using amounts of current flowing through the battery 40 detected at certain different times using the battery sensor 42. In addition, the amount of change ΔSOC in the SOC is a value calculated using an SOC at each time calculated using an output voltage of the battery 40 detected at certain different times using the battery sensor 42.

The estimation unit 301 estimates a deterioration state of the battery 40 using a full charge capacity (=ΔAh/ΔSOC) that is acquired by dividing the amount of change ΔAh in the charging/discharging amount by the amount of change ΔSOC in the charging state. The deterioration state of the battery 40 is a value that is calculated with higher accuracy in the case of charging/discharging having a large ΔSOC than in the case of charging/discharging having a small ΔSOC. In addition, the amounts ΔAh and ΔSOC, for example, may be calculated by either the diagnosis device 100 or the control unit 36.

The deriving unit 302 derives an index value representing validness of data used for estimating a deterioration state. Data used for estimating a deterioration state, for example, includes data representing an amount of change ΔSOC in the charging rate of the battery 40. The validness of data, for example, is the reliability of the data. For this reason, an index value, for example, corresponds to a value representing the reliability of the battery 40 for a deterioration state. The index value is a value corresponding to an amount of change ΔSOC in the charging rate (SOC) of the battery 40 according to charging/discharging during running of the vehicle 10.

The deriving unit 302 derives an index value on the basis of the amount of change ΔSOC in the charging rate of the battery 40 according to charging/discharging of the battery 40. In addition, the deriving unit 302 derives an index value on the basis of the number of times of acquiring an output of the battery sensor 42 (the number of times of capacity learning) as data used for estimation by the estimation unit 301. An output of the battery sensor 42 described here, for example, is an output of data representing that charging/discharging in which the amount of change ΔSOC in the SOC is equal to or larger than a predetermined amount has been performed during the running of the vehicle 10. Hereinafter, charging/discharging in which an amount of change ΔSOC in the SOC is equal to or larger than a predetermined amount (charging/discharging having a large ΔSOC) will be referred to as “capacity learning”, and the number of times of performing capacity learning will be referred to as the “number of times of capacity learning.”

The deriving unit 302 derives an index value on the basis of the number of times of capacity learning during running of the vehicle 10. The index value, for example, is a value corresponding to the number of times of capacity learning within a predetermined period. More specifically, as the index value, for example, a small value is associated with a small number of times of capacity learning, and a large value is associated with a large number of times of capacity learning.

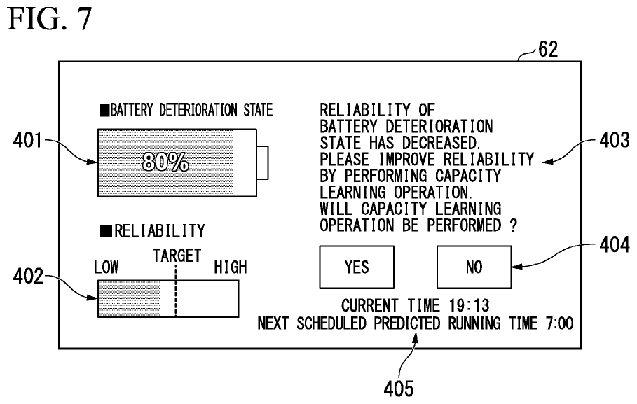

Here, for example, the storage unit 310 stores a history of capacity learning data including information representing that a capacity learning has been performed and information representing a date and time and a place at which each capacity learning has been performed. In addition, the storage unit 310 stores a table (see FIG. 7) in which the number of times of capacity learning and an index value (a value representing reliability) are associated with each other. For example, the deriving unit 302 calculates the number of times of capacity learning within a predetermined period by referring to the storage unit 310 and derives an index value corresponding to the calculated number of times of capacity learning by referring to the table stored in the storage unit 310. In addition, the storage unit 310, for example, is realized by a storage device such as a flash memory.

The index value is not limited to a value corresponding to the number of times of capacity learning. For example, the index value may be a value corresponding to a value (for example, a sum of squares of ΔSOC) acquired from an amount of change ΔSOC of the charging rate of the battery 40 according to charging/discharging of the battery 40. More specifically, the index value, for example, may be a value corresponding to a value (a sum of squares of ΔSOC) acquired from the latest capacity learning. In this way, the ΔSOC can be formed to be marked, and thus, even when a sum of squares of ΔSOC is used, the deterioration state of the battery 40 can be estimated with high accuracy.

In addition, the index value, for example, may be a value corresponding to the number of times of specific charging/discharging operations (capacity learning operations) performed by the charger 200. The capacity learning operation is an operation of performing charging/discharging having a large amount of change ΔSOC in the SOC that is performed by the charger 200 when the vehicle stops for a predetermined time. The index value may be a value corresponding to the number of times of capacity learning within a predetermined period.

In a case in which an index value acquired by the deriving unit 302 is equal to or smaller than a predetermined value (threshold), the approval unit 303 causes the output unit 304 to output information requesting an approval for performing a capacity learning operation using an external charger (the charger 200) supplying power to the battery 40 (hereinafter, referred to as “an approval for a capacity learning operation”). The information output from the output unit 304, for example, is information urging the execution of a capacity learning operation and is displayed on the display device 60.

When causing the output unit to output information for requesting an approval for a capacity learning operation, the approval unit 303 gives a notification of execution of a capacity learning operation using the charger 200 by using an image or speech. For example, in a case in which the number of times of capacity learning within a predetermined period is equal to smaller than a threshold, the approval unit 303 causes the output unit 304 to output information for requesting an approval for a capacity learning operation. In addition, in a case in which the index value is set to a value corresponding to a value (a sum of squares of ΔSOC) acquired from a capacity learning, the approval unit 303 may cause the output unit 304 to output information for requesting an approval for a capacity learning operation in a case in which the sum of squares of ΔSOC is equal to or smaller than the threshold.

The acceptance unit 305 accepts a user's input. The acceptance unit 305 accepts whether a capacity learning operation is executed using a touch panel of the display unit 62 of the display device 60. The approval unit 303 executes a process for performing a capacity learning operation on the basis of the user's input accepted by the acceptance unit 305. More specifically, in a case in which there is an input (approval) indicating execution of a capacity learning operation using the acceptance unit 305, the approval unit 303 outputs information for requesting a capacity learning operation to the request unit 306. In addition, in a case in which there is an input indicating execution of a capacity learning operation, the approval unit 303, for example, may output reservation information for executing a capacity learning operation after a predetermined time to the request unit 306.

The request unit 306 requests the charger 200 supplying power to the battery 40 to perform a capacity learning operation on the basis of the process of the approval unit 303. In addition, in a case in which the index value derived by the deriving unit 302 is equal to or smaller than a predetermined value (threshold), the request unit 306 may request the charger 200 supplying power to the battery 40 to perform a capacity learning operation regardless of presence/absence of an approval from the approval unit 303.

In addition, for example, in a case in which the number of times of capacity learning within a predetermined period is equal to or smaller than a predetermined value (threshold), the request unit 306 may request the charger 200 supplying power to the battery 40 to perform a capacity learning operation regardless of presence/absence of an approval from the approval unit 303. In addition, in a case in which the index value is set to a value corresponding to a value (a sum of squares of ΔSOC) acquired from capacity learning, the request unit 306 may request a capacity learning operation in a case in which the sum of squares of ΔSOC is equal to or smaller than a threshold.

The acquisition unit 307 acquires information representing a parking status of the vehicle 10. The acquisition unit 307, for example, acquires information representing a parking status of the vehicle 10 from a running history of a navigation device mounted in the vehicle 10 and the like. The information representing a parking status, for example, includes position information representing a parked position of the vehicle 10 and information of a parking time of the vehicle 10 predicted on the basis of the running history.

In a case in which a parking status represented by the information acquired by the acquisition unit 307 satisfies a predetermined condition, the approval unit 303 causes the output unit 304 to output information for requesting an approval for a capacity learning operation.

The predetermined condition, for example, is a condition under which a charging time that is equal to or longer than a predetermined time (for example, 6 hours) can be secured. For example, the approval unit 303 may determine whether or not a parking status of the vehicle 10 is under a predetermined condition by referring to the running history.

In addition, in a case in which the parking status represented by the information acquired by the acquisition unit 307 satisfies a predetermined condition, the request unit 306 requests a capacity learning operation. Also in such a case, the request unit 306 may request a capacity learning operation in a case in which a user's approval is acquired from the approval unit 303.

The charging control unit 210 of the charger 200 includes a communication unit 211 and an execution unit 212. The communication unit 211 receives a request for a capacity learning operation from the diagnosis device 100 (the request unit 306). In a case in which a request for a capacity learning operation has been received by the communication unit 211, the execution unit 212 executes the capacity learning operation for the battery 40. For example, the capacity learning operation includes a state in which charging/discharging is performed for the battery 40 and a pause state in which predetermined charging/discharging is not performed. More specifically, the capacity learning operation is an operation in which charging/discharging (for example, discharging) is performed after the battery 40 comes into a stable state, and charging/discharging (for example, charging) is performed after a stable state is formed after discharging.

The battery 40 is charged and discharged in accordance with a capacity learning operation by performing the capacity learning operation using the charger 200. When the capacity learning operation is completed, the execution unit 212 outputs information indicating the completion of the learning operation to the communication unit 211. When the information indicating the completion of the learning operation is received from the execution unit 212, the communication unit 211 transmits notification information indicating the completion of the capacity learning operation to the diagnosis device 100. By performing such a capacity learning operation, the diagnosis device 100 can acquire data having a large amount of change ΔSOC in the SOC and can calculate a deterioration state of the battery 40 with high accuracy.

In addition, when information for requesting an approval for a capacity learning operation is output by the output unit 304, the approval unit 303 causes the output unit 304 to output information representing a deterioration state of the battery 40 and an index value. When such information is received from the output unit 304, the display device 60 (the display control unit 64) causes the display unit 62 to display a notification image urging the execution of a capacity learning operation, a notification image representing a deterioration state of the battery 40, and a notification image representing an index value (reliability). In addition, a timing at which the display unit 62 is caused to display such images may be an arbitrary timing at which an operation for displaying such images is accepted from a user, a timing at which the deterioration state of the battery 40 becomes a predetermined value or less, or a timing at which the index value becomes a predetermined value or less.

### [Process of Requesting Capacity Learning Operation]

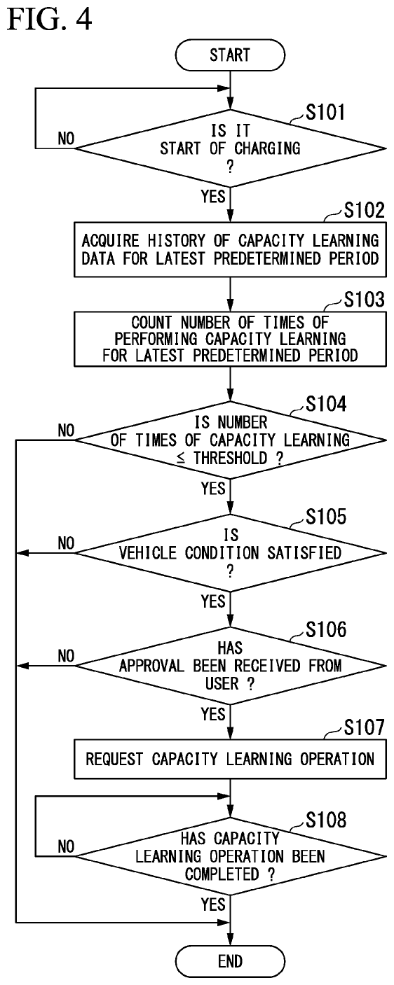

Next, the process of requesting a capacity learning operation performed in accordance with the number of times of capacity learning will be described with reference to FIG. 4. FIG. 4 is a flowchart showing one example of the process of requesting a capacity learning operation that is performed by the diagnosis device 100.

In FIG. 4, the diagnosis device 100 determines whether it is the start of charging or not (Step S101). The start of charging is a status in which start of charging can be performed. For example, the start of charging is detection of a connection between the charging port 70 and the charger 200 using the charging cable 220, detection of the vehicle 10 to be positioned near the charger 200 using the position information, or acceptance of an operation input for charging start from a user. In addition, in the case of the charging system of a non-contact type, the start of charging may be detection of electromagnetic waves of which an intensity is equal to or higher than a predetermined value.

The diagnosis device 100 waits until the start of charging is performed (Step S101: No). In a case in which the start of charging is determined, the diagnosis device 100 acquires a history of capacity learning data for a latest predetermined period (Step S102). Then, the diagnosis device 100 counts (sums) the number of times of capacity learning of a latest predetermined period (for example, the latest one month) using the acquired history of capacity learning data (Step S103). The sum of the numbers of times of capacity learning, for example, corresponds to the reliability of data used for estimating a deterioration state of the battery 40.

Next, the diagnosis device 100 determines whether or not the number of times of capacity learning is equal to or smaller than a threshold (for example, three) (Step S104).

In a case in which the number of times of capacity learning is not equal to or smaller than the threshold (Step S104: No), in other words, in a case in which it is recognized that there is a predetermined reliability in the data used for estimating the deterioration state, the diagnosis device 100 ends the series of processes.

On the other hand, in a case in which the number of times of capacity learning is equal to or smaller than the threshold (Step S104: Yes), in other words, in a case in which it is not recognized that there is a predetermined reliability in the data used for estimating the deterioration state, the diagnosis device 100 determines whether or not a vehicle condition (predetermined condition) is satisfied (Step S105). The vehicle condition, for example, is a condition in which it is predicted that a capacity learning operation can be performed and, for example, is a condition in which the vehicle 10 stops at a house, and it is predicted that a predetermined time (for example, 6 hours) can be secured until the next running

In a case in which it is determined that the vehicle condition is not satisfied (Step S105: No), in other words, for example, in a case in which it is determined that a predetermined time for performing a capacity learning operation is cannot be secured, the diagnosis device 100 ends a series of the processes. On the other hand, in a case in which it is determined that the vehicle condition is satisfied (Step S105: Yes), in other words, for example, in a case in which it is determined that a predetermined time for performing a capacity learning operation can be secured, the diagnosis device 100 displays a screen for accepting an approval for performing a capacity learning operation from a user and determines whether or not the approval for performing a capacity learning operation has been accepted from the user (Step S106).

In a case in which an approval for performing a capacity learning operation has not been accepted from the user (Step S106: No), the diagnosis device 100 ends a series of the processes. On the other hand, in a case in which an approval for performing a capacity learning operation has been accepted from the user (Step S106: Yes), the diagnosis device 100 requests the charger 200 to perform a capacity learning operation (Step S107). The charger 200 (the charging control unit 210) receives this request and executes a capacity learning operation.

Then, the diagnosis device 100 determines whether or not the capacity learning operation has been completed (Step S108). The completion of the capacity learning operation, for example, is reception of a completion notification of the capacity learning operation from the charging control unit 210. The diagnosis device 100 waits until the capacity learning operation is completed (Step S108: No). On the other hand, when the capacity learning operation is completed (Step S108: Yes), the diagnosis device 100 ends a series of the processes.

According to the process described above, the diagnosis device 100 can perform a capacity learning operation in a case in which the number of times of capacity learning is equal to or smaller than the threshold, and accordingly, the reliability of data used for estimating a deterioration state of the battery 40 can be improved. In addition, in the process described above, a capacity learning operation is executed in a case in which the number of times of capacity learning for a latest predetermined period is equal to or smaller than the threshold (Step S104: Yes) but is not limited thereto. For example, a capacity learning operation may be executed in a case in which a sum of squares of ΔSOC of the latest capacity learning data is equal to or smaller than the threshold. Also in such a case, the reliability of data used for estimating a deterioration state of the battery 40 can be improved, and the deterioration state of the battery 40 can be estimated with high accuracy.

### [Flow at Time of Performing Capacity Learning Operation]

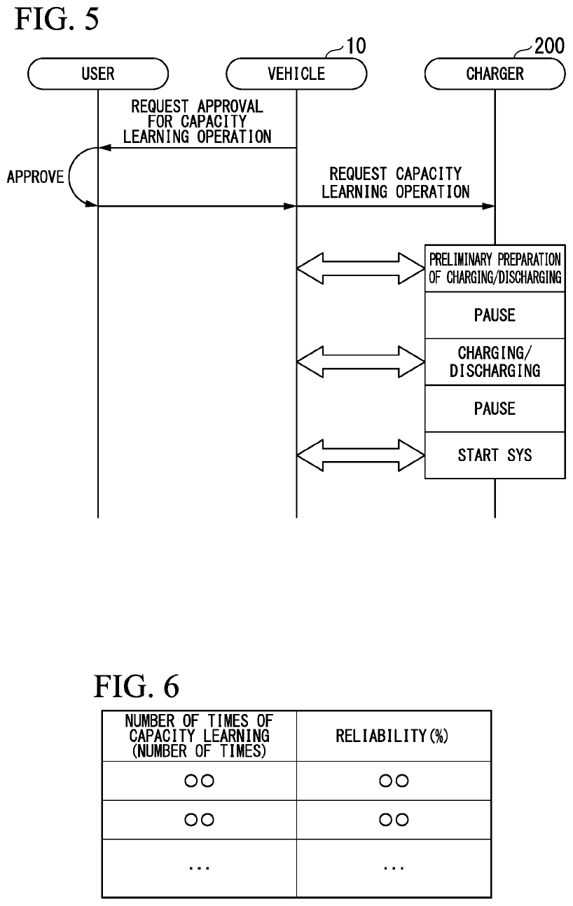

Next, the flow at the time of performing a capacity learning operation will be described with reference to FIG. 5. FIG. 5 is a sequence diagram showing one example when a capacity learning operation is performed. In FIG. 5, when the vehicle condition is satisfied, the vehicle 10 (the diagnosis device 100) requests an approval for a capacity learning operation from a user. When an approval is received from the user, the vehicle 10 requests the charger 200 to perform a capacity learning operation. When a request for a capacity learning operation is received from the vehicle 10, the charger 200 (the charging control unit 210) executes the capacity learning operation.

In the capacity learning operation, the charging control unit 210 performs preliminary preparation of charging/discharging. In the preliminary preparation of charging/discharging, for example, charging/discharging (for example, discharging) is performed such that the SOC becomes a first specified value. In addition, before charging/discharging in the preliminary preparation of charging/discharging, a pause period may be arranged for stabilizing the battery 40. After performing the preliminary preparation of charging/discharging, the charging control unit 210 pauses charging/discharging until a first pause period elapses for stabilizing the battery 40. When the first pause period elapses, the charging control unit 210 performs charging/discharging (for example, charging) until the SOC becomes a second specified value.

When charging/discharging is performed until the SOC becomes the second specified value, the charging control unit 210 pauses charging/discharging until a second pause period elapses for stabilizing the battery 40. When the second pause period elapses, the charging control unit 210 starts a predetermined system and notifies the vehicle 10 (the diagnosis device 100) that the capacity learning operation has been completed. In this way, the capacity learning operation is executed. When a completion notification indicating the completion of the capacity learning operation has been is received, the diagnosis device 100 stores an indication of execution of the learning operation and date and time at which the learning operation has been performed in a predetermined storage area (the storage unit 310). [Relation Between Number of Times of Capacity Learning and Reliability]

Next, a relation between the number of times of performing capacity learning and reliability will be described with reference to FIG. 6. FIG. 6 is an explanatory diagram showing one example of a reliability identification table used for identifying a reliability from a sum of the numbers of times of capacity learning. In FIG. 6, a reliability determination table is a table in which a sum of the numbers of times of capacity learning and reliability of data used for estimating a deterioration state are associated with each other. The number of times of capacity learning is a value (a total number) acquired by counting the number of times of capacity learning for a latest predetermined period. The reliability is a value (a value represented as a percentage) set in correspondence with the number of times of capacity learning.

For example, in a case in which a sum of the numbers of times of capacity learning is equal to or smaller than a threshold, the reliability is a value corresponding to the number of times of capacity learning (for example, a smaller value as the number of times of capacity learning decreases). In addition, in a case in which a sum of the numbers of times of capacity learning exceeds a threshold, the reliability has a constant value. In a case in which the reliability (an index value) is configured to be identified using a sum of squares of ΔSOC of capacity learning data, a reliability identification table in which a sum of squares of ΔSOC and the reliability are associated with each other may be prepared.

### [One Example of Display Screen]

Next, one example of a display screen relating to a deterioration state of the battery 40 displayed on the display unit 62 will be described with reference to FIG. 7. FIG. 7 is an explanatory diagram showing one example of a display screen relating to a deterioration state of the battery 40. As shown in FIG. 7, a deterioration state suggesting image 401 representing a deterioration state of the battery 40, a reliability suggesting image 402 representing reliability of data used for estimating a deterioration state, a notification image 403 inquiring of a user about presence/absence of execution of a capacity learning operation, approval acceptance buttons 404, and time information 405 are displayed on the display unit 62. The deterioration state suggesting image 401 is an image representing a deterioration state of the battery 40 in a graph form (a bar graph form) together with a numerical value representing a percentage. However, the deterioration state suggesting image 401 may be an image displaying only a numerical value representing a percentage or an image displaying only a graph.

In addition, the reliability suggesting image 402 displays reliability of data used for estimating a deterioration state of the battery 40 in a graph form. The reliability is a value identified using the number of times of capacity learning for a latest predetermined period (see a reliability identification table shown in FIG. 6). The reliability suggesting image 402 may be an image representing a numerical value representing a percentage instead of a graph or together with a graph.

In FIG. 7, the reliability suggesting image 402 includes an image representing a target value. Accordingly, a user can be prompted to recover the reliability. In addition, the target value may be changeable in accordance with the current reliability. More specifically, the target value may be lowly set in a case in which the reliability is low and may be highly set in a case in which the reliability is high. In this way, the target value can be set to a value closed to the current reliability, and accordingly, a user can be more prompted to recover the reliability.

The notification image 403 is one example of an image representing information for requesting an approval for a capacity learning operation. More specifically, the notification image 403 is an image representing a notification indicating that a learning operation is required for recovering the reliability or a notification for urging a capacity learning operation. The approval acceptance buttons 404, for example, accept whether or not a capacity learning operation is performed using a touch panel of the display unit 62.

The time information 405 represents a current time and a predicted time for the next running It can be indirectly notified to a user that a predetermined time (for example, six hours) for performing a capacity learning operation can be secured from the current time and the predicted time for the next running In addition, a notification indicating that a predetermined time is required for a capacity learning operation may be performed together with the time information 405 or instead of the time information 405. In addition to the details shown in FIG. 7, for example, a notification indicating that the battery 40 is not fully charged may be performed until the learning operation ends, or a notification indicating running of the vehicle 10 is avoided until the learning operation ends may be performed.

According to the diagnosis device 100 of the embodiment described above, in a case in which an index value (for example, the number of times of capacity learning) representing the validness of data used for estimating a deterioration state of the battery 40 is equal to or smaller than the threshold, a user is requested to approve a capacity learning operation. Accordingly, a capacity learning operation can be configured not to be performed when it is not intended by a user, and thus, it can be inhibited that a capacity learning operation causes a trouble to the user. On the other hand, for example, when there is no trouble for a user such as when the user does not use the vehicle 10, a capacity learning operation can be performed. In this way, the reliability of data used for estimating the deterioration state of the battery 40 can be improved, and accordingly, the deterioration state of the battery 40 can be estimated with high accuracy.

In addition, in a case in which the parking status of the vehicle 10 satisfies a predetermined condition, the diagnosis device 100 requests a user to perform an approval for a capacity learning operation. Accordingly, when a user is predicted not to use the vehicle 10, a user's approval can be acquired. In this way, an approval for a capacity learning operation can be acquired at a timing that is optimal for a user such as a timing at which the user does not use the vehicle 10. For this reason, a notification or an operation for acquiring an approval can be configured not to be troublesome for a user.

In addition, when requesting a user to perform an approval for a capacity learning operation, the diagnosis device 100 notifies a user of the deterioration state suggesting image 401 (see FIG. 7) representing a deterioration state of the battery 40 and the reliability suggesting image 402. Accordingly, the user can perceive the deterioration state of the battery 40 and the reliability (accuracy). For this reason, the user can be prompted to perform a capacity learning operation. In other words, the user can be prompted to recover the reliability of data used for estimating the deterioration state of the battery 40 and improve the accuracy of the estimated deterioration state.

In addition, in a case in which an index value (for example, the number of times of capacity learning) representing the validness of data used for estimating the deterioration state of the battery 40 is equal to or smaller than the threshold, the diagnosis device 100 according to this embodiment requests the charging control unit 210 to perform a capacity learning operation. Accordingly, the battery 40 can be charged or discharged in accordance with a capacity learning operation. In this way, the reliability of data used for estimating the deterioration state of the battery 40 can be improved, and accordingly, the deterioration state of the battery 40 can be estimated with high accuracy.

In addition, in a case in which the parking status of the vehicle 10 satisfies a predetermined condition, the diagnosis device 100 requests the charging control unit 210 to perform a capacity learning operation. Accordingly, the capacity learning operation can be performed when the user is predicted not to use the vehicle 10.

In this way, the capacity learning operation can be performed when there is no trouble for the user such as when the user does not use the vehicle 10.

In addition, in this embodiment, a capacity learning operation is an operation including a state in which charging/discharging of the battery 40 is performed and a pause state in which charging/discharging is not performed. Accordingly, charging/discharging having a large amount of change ΔSOC in the charging rate can be performed in a state in which the battery 40 is stabilized. Accordingly, the reliability of data used for estimating the deterioration state of the battery 40 can be improved. In this way, the deterioration state of the battery 40 can be estimated with high accuracy.

### MODIFIED EXAMPLE 1

Next, Modified example 1 according to this embodiment will be described. In the embodiment described above, although a configuration in which all the functional units of the diagnosis device 100 according to the present invention are included in the vehicle 10 has been described, a configuration in which some or all of the functional units of the diagnosis device 100 are included in another device (for example, a center server) will be described.

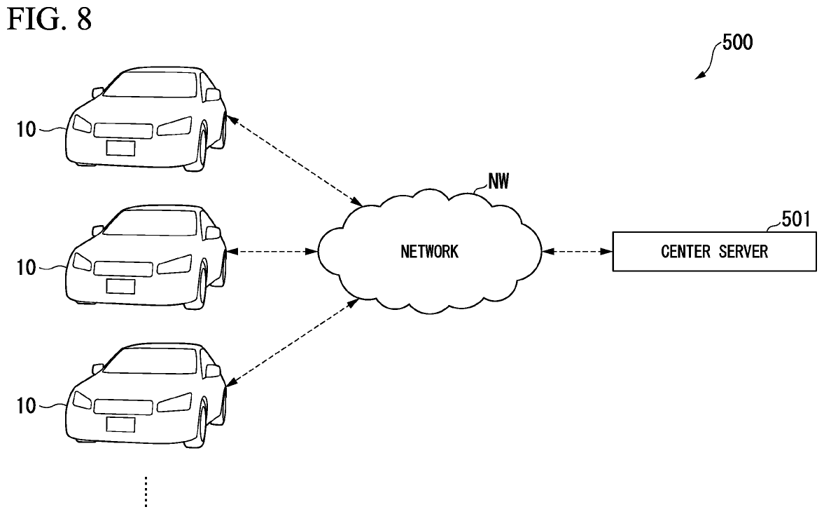

FIG. 8 is an explanatory diagram showing Modified example 1 of this embodiment.

FIG. 8 is an explanatory diagram showing an example of the configuration of a diagnosis system 500. The diagnosis system 500 is a battery control system that manages a deterioration state and the like of a battery 40 mounted in a vehicle 10. The diagnosis system 500 includes a plurality of vehicles 10 and a center server 501. The vehicle 10 and the center server 501 communicate with each other through a network NW. The network NW, for example, includes the Internet, a wide area network (WAN), a local area network (LAN), a provider device, a radio base station, and the like.

Each of the plurality of vehicles 10 includes a communication device. The communication device includes a radio module used for connecting to a cellular network or a Wi-Fi network. The communication device acquires information representing an output of a battery sensor 42 and transmits the acquired information to the center server 501 through the network NW shown in FIG. 8. In addition, the communication device receives information transmitted from the center server 501 through the network NW. The communication device outputs the received information to the display device 60.

The center server 501 manages information relating to the battery mounted in the vehicle 10 on the basis of information transmitted from the plurality of vehicles 10 (communication devices). Here, the center server 501 may have the functions of the estimation unit 301, the deriving unit 302, the approval unit 303, the output unit 304, the acceptance unit 305, the request unit 306, and the acquisition unit 307 shown in FIG. 3.

Described more specifically, the center server 501 may receive information representing an output of the battery sensor 42 from the communication device of the vehicle 10 and estimate the deterioration state of the battery 40 on the basis of the information (the estimation unit 301). In addition, the center server 501 may receive data used for estimating the deterioration state from the communication device of the vehicle 10 and derive an index value representing the validness of data used for estimating the deterioration state on the basis of the data (deriving unit 302).

In addition, in a case in which the derived index value is equal to or smaller than a predetermined value, the center server 501 may output (transmit) information for requesting a user's approval (the approval unit 303 and the output unit 304) to the vehicle 10. In addition, the center server 501 may accept a user's input through the vehicle 10 (the acceptance unit 305). In addition, in a case in which the derived index value is equal to or smaller than a predetermined value, the center server 501 may transmit information for requesting the charger 200 to perform a capacity learning operation to the vehicle 10 (the request unit 306). Furthermore, the center server 501 may acquire information representing a parking status of the vehicle from the vehicle (the acquisition unit 307).

In addition, in Modified example 1, the center server 501 may include at least some of the functional units of the diagnosis device 100. More specifically, for example, the center server 501 may include only the estimation unit 301 or may include the estimation unit 301 and the deriving unit 302. In such a case, functions not included in the center server 501 may be included on the vehicle 10 side.

In addition, the center server 501, for example, may receive information relating to the deterioration state of the battery (information or an index value representing a deterioration state) and use status information (a battery temperature, a running load, an average SOC, the number of times of charging, and the like) from each vehicle 10 and calculate and manage an average value of each value thereof for the plurality of vehicles 10. The vehicle 10 may receive an average value calculated by the center server 501 and display the received average value and information relating to the battery of the own vehicle on the display unit 62 in association with each other.

Accordingly, a user can perceive the deterioration state and the reliability of the battery 40 of the own vehicle by comparing them with average values of the other vehicles 10. In addition, in a case in which the reliability of data used for estimating the deterioration state of the battery 40 is low, by comparing the reliability with an average thereof for the other vehicles 10, the user can be prompted more to recover the reliability.

### MODIFIED EXAMPLE 2

Next, Modified example 2 of this embodiment will be described. In the embodiment described above, although a configuration in which information representing the parking status of the vehicle 10 is acquired from the running history of the navigation device mounted in the vehicle 10 has been described, a configuration in which the information is acquired from a schedule of another device (for example, a communication terminal device such as a smartphone) will be described.

In Modified example 2, the vehicle 10 includes a communication device. This communication device is communicatively connected to a communication terminal device (for example, a smartphone, a tablet terminal, a laptop PC, or the like) in a wired or wireless manner. An application of a scheduler used for managing a user's schedule is installed in the communication terminal device. By receiving user's schedule information from the communication terminal device, the communication device of the vehicle 10 can acquire information of a scheduled parking time of the vehicle 10. Accordingly, a capacity learning operation can be performed in a case in which a charging time that is equal to or longer than a predetermined time (for example, 6 hours) can be secured.

In addition, for example, the communication device of the vehicle 10 refers to user's schedule information received from the communication terminal device and, for example, in a case in which running for a long movement distance is scheduled the next day, can be configured not to perform a capacity learning operation. In this way, by using user's schedule information, a capacity learning operation can be performed in accordance with a user's schedule.

While preferred embodiments of the invention have been described and shown above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A diagnosis device comprising:
an estimation unit that is configured to estimate a deterioration state of a secondary battery based on an output of a sensor mounted in the secondary battery supplying power for running driving of a vehicle;
a deriving unit that is configured to derive an index value representing validness of data used for estimating the deterioration state; and
a request unit that is configured to request an external charger supplying power to the secondary battery to perform a specific charging/discharging operation in a case in which the index value derived by the deriving unit is equal to or smaller than a predetermined value.

2. The diagnosis device according to claim 1,
wherein the deriving unit is configured to derive the index value based on a number of times of acquiring the output of the sensor as the data used for estimation performed by the estimation unit.

3. The diagnosis device according to claim 1,
wherein the deriving unit is configured to derive the index value based on an amount of change in a charging rate of the secondary battery in accordance with charging/discharging of the secondary battery.

4. The diagnosis device according to claim 1, further comprising
an acquisition unit that is configured to acquire information representing a parking status of the vehicle,
wherein the request unit is configured to perform the requesting in a case in which the parking status represented by the information acquired by the acquisition unit satisfies a predetermined condition.

5. A diagnosis system comprising:
the diagnosis device according to claim 1; and
the external charger including:
a communication unit that is configured to receive the request from the diagnosis device; and
an execution unit that is configured to execute the specific charging/discharging operation for the secondary battery in a case in which the request is received by the communication unit.

6. The diagnosis system according to claim 5,
wherein the specific charging/discharging operation includes a state in which charging/discharging is performed for the secondary battery and a pause state in which charging/discharging is not performed.

7. A diagnosis method performed using a computer mounted in a vehicle, the diagnosis method comprising:
estimating a deterioration state of a secondary battery based on an output of a sensor mounted in the secondary battery supplying power for running driving of the vehicle;
deriving an index value representing validness of data used for estimating the deterioration state; and
requesting an external charger supplying power to the secondary battery to perform a specific charging/discharging operation in a case in which the derived index value is equal to or smaller than a predetermined value.

8. A computer-readable non-transitory recording medium including a program causing a computer mounted in a vehicle to execute:
estimating a deterioration state of a secondary battery based on an output of a sensor mounted in the secondary battery supplying power for running driving of the vehicle;
deriving an index value representing validness of data used for estimating the deterioration state; and
requesting an external charger supplying power to the secondary battery to perform a specific charging/discharging operation in a case in which the derived index value is equal to or smaller than a predetermined value.
